(19) United States
(12) Patent Application Publication
(10) Pub. No.: US 2026/0019275 A1
(43) Pub. Date: Jan. 15, 2026

(54) Dynamic BEI Signature _BEISign_ System for Global 8.2 Billion Users Covering 999 Demands, 365 Industries, All Currencies and Resources Across 1,600 Infinite Ecosystems with Multimodal, Governance, Notarization, Auditable and Anti_Audit Features

(71) Applicant: FURONG BEI, SAN GABRIEL, CA (US)

(72) Inventor: FURONG BEI, SAN GABRIEL, CA (US)

(21) Appl. No.: 19/196,039

(22) Filed: May 1, 2025

(51) Int. Cl. H04L 9/32; H04L 9/08

(52) U.S. Cl. CPC H04L 9/3247; H04L 9/0852; H04L 9/3268; H04L 9/3271

(57) ABSTRACT

A computer-implemented protocol, BEISIGN, generates verifiable records for communications and financial messages by combining risk evaluation and presence challenge with dual signatures from a secure enclave and a guardian module. The record is bound to an evidence envelope referencing a TimeTape snapshot and supports revocation, rollback, and zero-knowledge validation. Overlays for SIP/WebRTC and ISO 20022 allow early trust establishment and cross-chain clearing via a Settlement Bus that performs layer-2 batching, atomic netting, and deterministic rollback across CBDC, stablecoin, and banking rails. The protocol enables printable verifiable reports with QR-based verification and governs licensing of data via tokens.

A computer-implemented protocol, BEISIGN, binds a subject decentralized identity (DID) and an institutional identity (EID) to communications, reports, and financial messages by dual signatures. A secure enclave issues a primary signature and an AI guardian issues a secondary signature upon risk triggers, while a TimeTape snapshot captures device, geo-network, and transport metadata at session setup. Evidence envelopes support revocation, rollback, and zero-knowledge validation hooks. The system overlays SIP/WebRTC signaling and ISO 20022 rails with BEISIGN headers and a Settlement Bus that performs layer-2 batching and cross-ledger atomic netting with rollback. Assets minted from behavior, identity, life, and time may be listed and cleared on BEIGX, BEISX, or BEICX under BEISIGN verification. The approach enables SIM-less handles, printable verifiable reports with QR and revocation metadata, post-quantum cryptographic encapsulation, and IoT attestation.

### TECHNICAL FIELD

The present disclosure relates to computer-implemented security protocols and, more particularly, to a dual-signature protocol that binds a subject decentralized identity (DID) and an institutional identity (EID) to communications, reports, and financial messages to achieve trusted circulation, transaction, and clearing.

### BACKGROUND

Conventional telephone numbers and SIM-bound identities are vulnerable to spoofing, SIM-swap, and cross-channel impersonation. Email and instant-messaging schemes provide non-uniform authentication. Existing financial rails and clearing schemes lack a verifiable envelope that persists across multi-network hops and heterogeneous ledgers. There remains a need for a unified protocol that delivers verifiable identity, revocation, rollback auditability, and deterministic settlement.

### SUMMARY

In one embodiment, a computer-implemented method generates a verifiable record by fusing risk evaluation and presence challenge, obtaining a primary signature from a secure enclave (TEE/HSM) and a secondary signature from an AI guardian, and binding the result to an evidence envelope with rollback and zero-knowledge validation hooks.

In another embodiment, a system provides signaling overlays for SIP/WebRTC and message overlays for ISO 20022, together with a Settlement Bus that performs layer-2 batching, atomic netting, and deterministic rollback across CBDC, stablecoin, and bank RTGS bridges.

In a further embodiment, SIM-less identifiers enable session establishment using user handles; printable verifiable reports embed a QR and revocation metadata; post-quantum cryptographic envelopes encapsulate BEISIGN signatures.

### BRIEF DESCRIPTION OF THE DRAWINGS

FIG. 1 illustrates a BEISIGN system overview and data flows between a secure enclave (101), an AI guardian (102), human presence challenges (103), a BEISIGN record (104), a TimeTape snapshot (105), and a Settlement Bus (106); flows (111-115) are indicated.

FIG. 2 shows a TimeTape structure with snapshot fields (200, 210-235) and forced-write thresholds.

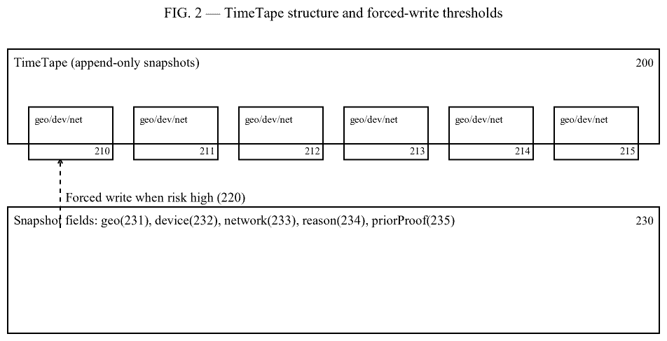

FIG. 3 shows a dual-signature flow with primary/guardian signatures (300, 320, 340).

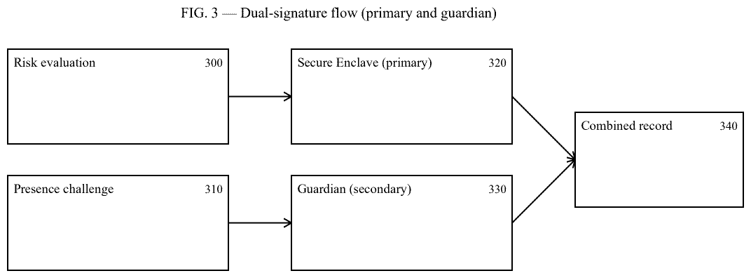

FIG. 4 shows a handshake where a caller endpoint (400) transmits signaling (420) to a callee endpoint (410); within the channel, headers X-BEISign-Cert (431) and X-BEISign-Ref (432) carry certificate references verified prior to session establishment.

FIG. 5 shows a printable verifiable report with QR (511) and revocation/meta (512).

FIG. 6 shows a Settlement Bus performing layer-2 batching and cross-chain atomic netting with rollback semantics (600-650).

FIG. 7 shows a tokenization pipeline where behavior (700), identity (710), life (720), and time (730) feed a minting engine (740) for listing on BEIGX/BEISX/BEICX (750) under BEISIGN verification.

FIG. 8 shows governance with parameter tuning and rollback auditing via reason code chains.

FIG. 9 shows notarization and exception workflows for evidence envelopes.

FIG. 10 shows secure handle resolution and policy synchronization to a cloud verifier.

FIG. 11 shows listing and clearing across BEIGX, BEISX, and BEICX exchanges.

FIG. 12 shows an ISO 20022 overlay: message (1200) to SupplementaryData (1210) to evidence-envelope reference (1220) with BIC/LEI mapping (1230).

### DETAILED DESCRIPTION

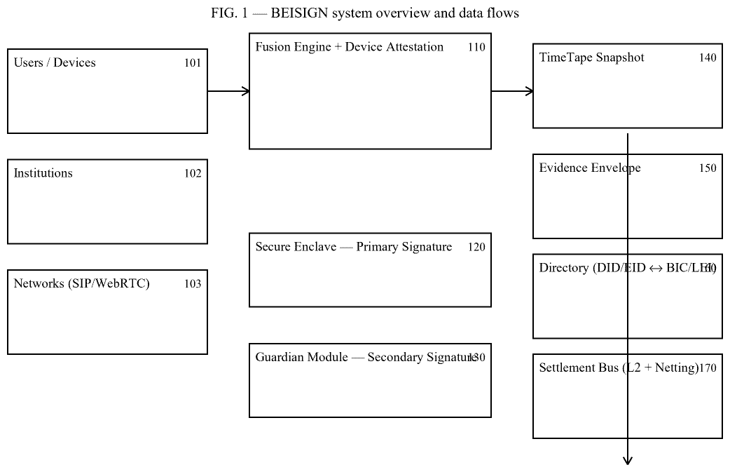

Referring to FIG. 1, a secure enclave (101) issues a primary signature over normalized inputs and a guardian (102) issues a secondary signature if a risk score exceeds a threshold derived from presence challenges (103) including liveness and device-bound cryptographic prompts. The signed object becomes a BEISIGN record (104) bound to a TimeTape (105) and a Settlement Bus (106) via flows (111-115).

The TimeTape captures geo, device attestation, network hops, transport tuples, and policy versions (200, 210-235), enforcing forced-write thresholds when risk or asset criticality is high.

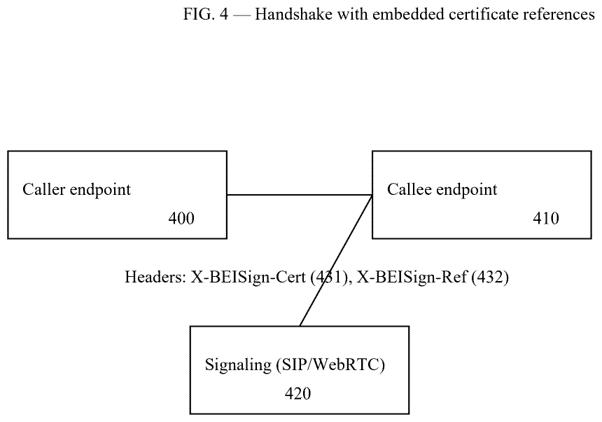

In FIG. 4, signaling (420) conveys certificate references X-BEISign-Cert (431) and X-BEISign-Ref (432) for pre-session verification between caller (400) and callee (410), reducing early-stage impersonation.

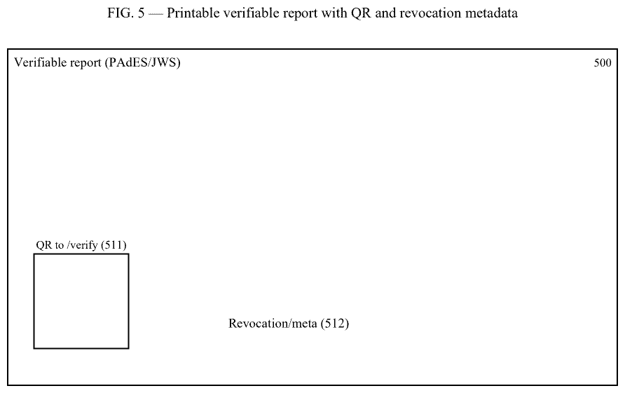

FIG. 5 provides a printable report embedding a QR (511) that resolves to a verifier endpoint and includes revocation metadata (512) supporting rollback with hash-linked reason codes.

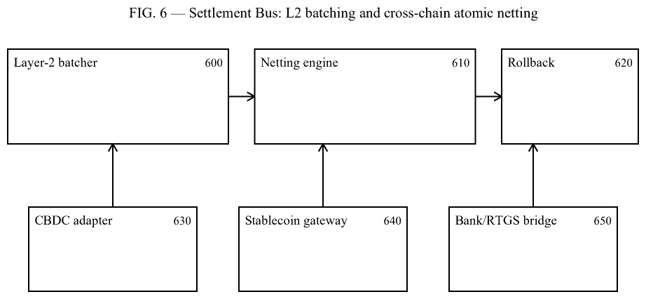

The Settlement Bus (FIG. 6) performs L2 batching, netting, commit-and-proof rollback across CBDC, stablecoin, and bank RTGS connectors (600-650).

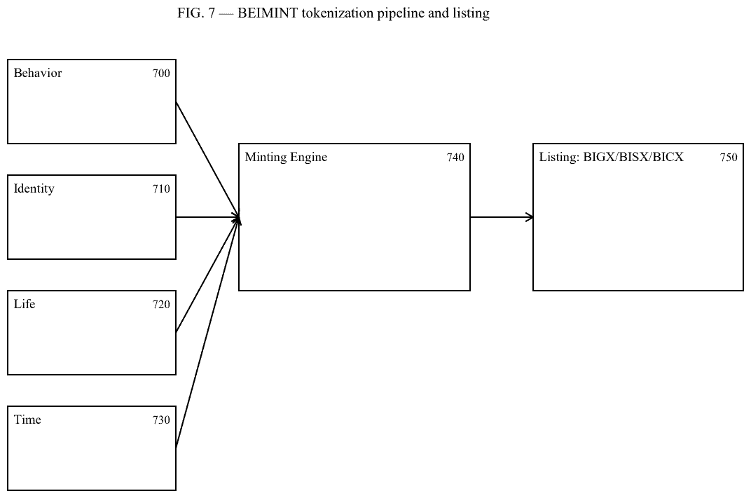

FIG. 7 maps behavior/identity/life/time to mintable units; assets list on BEIGX/BEISX/BEICX (750) under BEISIGN verification and policy constraints.

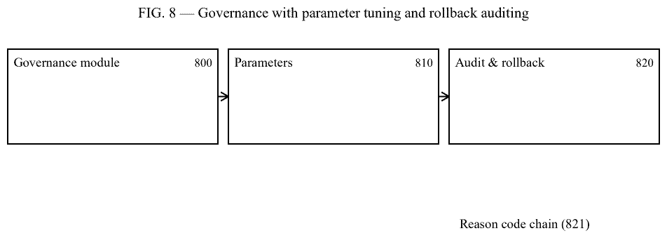

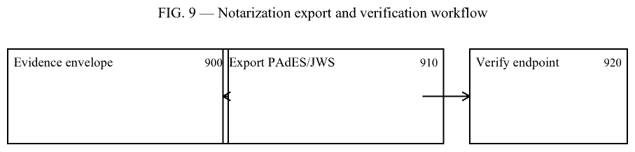

Governance (FIG. 8) tunes parameters and logs reason-coded rollbacks; FIG. 9 handles notarization and exceptions for evidence envelopes.

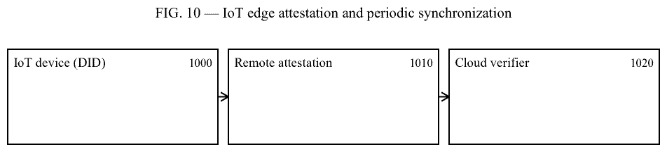

FIG. 10 resolves SIM-less handles to endpoints with policy sync to a cloud verifier.

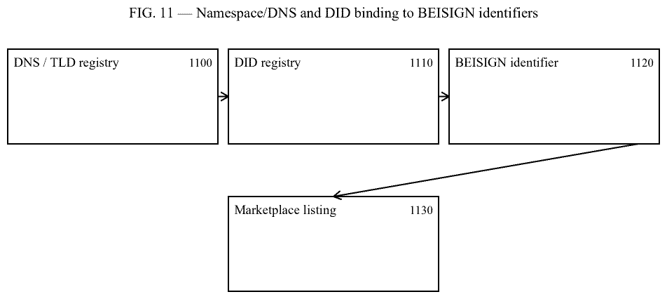

FIG. 11 details listing/clearing pipelines for BEIGX/BEISX/BEICX.

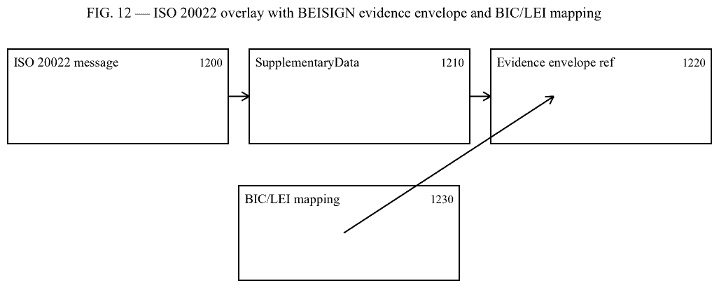

FIG. 12 overlays ISO 20022 by placing an evidence-envelope reference into SupplementaryData (1210); BIC/LEI mapping (1230) links institutional identifiers to BEISIGN records.

Post-quantum security: BEISIGN signatures may be encapsulated in lattice-, code-, or hash-based envelopes with negotiated downgrade.

IoT/edge: BEISIGN records may be generated on edge devices with periodic attestation sync to a cloud verifier.

Computer-readable medium: instructions stored on a non-transitory medium configure processors with a secure enclave to perform the sequences of [0018]-[0029], including cross-chain atomic netting and commit-and-proof rollback.

What is claimed is:

1. A computer-implemented method for generating a verifiable record, comprising: obtaining input data including at least one of communications context, medical or financial records, or identity credentials; evaluating risk and, when indicated, issuing a presence challenge; obtaining a primary signature from a secure enclave and a secondary signature from a guardian module; and binding the signatures to an evidence envelope with revocation, rollback, and zero-knowledge validation hooks.

2. A system for implementing verifiable reporting and value transfer, comprising: signaling overlays for SIP/WebRTC that convey certificate references within messages; a dual-signature engine configured to obtain a primary signature from a secure enclave and a secondary signature from a guardian module; and a Settlement Bus configured to perform layer-2 batching, atomic netting, and deterministic rollback across CBDC, stablecoin, and bank RTGS bridges, thereby enabling trusted circulation, transaction, and clearing across heterogeneous ledgers.

3. A non-transitory computer-readable medium storing instructions that, when executed by one or more processors configured with a secure enclave, cause the processors to perform the method of claim 1.

4. The method of claim 1, wherein medical reports are generated by transforming HL7 ORU\hat{ }R01 and/or FHIR DiagnosticReport resources to PAdES and/or JWS formats embedding a QR code and revocation metadata.

5. The method of claim 1, wherein a multi-model fusion engine applies batch-effect correction, quality control, and device attestation prior to inference.

6. The system of claim 2, wherein signaling messages include headers X-BEISign-Cert and X-BEISign-Ref that carry certificate references for pre-session validation.

7. The system of claim 2, wherein a TimeTape structure records append-only snapshots comprising at least geo information, device fingerprints, network state, model version, and reason codes, with forced-write thresholds under elevated risk.

8. The method of claim 1, wherein the verifiable record further comprises a printable report embedding a QR link to a verification endpoint.

9. The system of claim 2, wherein home or edge devices include secure elements that embed measurement fingerprints for attestation.

10. The system of claim 2, wherein assets minted from behavior, identity, life, and time inputs are listed and cleared on at least one of BEIGX, BEISX, or BEICX domain marketplaces operated under corresponding TLD domain names.

11. The system of claim 2, wherein a banking subsystem enables each BEI identity to serve as a sovereign banking node with account and messaging functions.

12. The non-transitory computer-readable medium of claim 3, wherein the instructions cause the processors to resolve user handles to communications endpoints in lieu of SIM cards and telephone numbers for session establishment.

13. The system of claim 2, wherein a quantum-resistant transport encapsulates BEISIGN signatures within post-quantum cryptographic envelopes selected from lattice-based, code-based, or hash-based families and supporting negotiated downgrade compatibility.

14. The non-transitory computer-readable medium of claim 3, wherein the instructions further cause the processors to perform cross-chain atomic netting with commit-and-proof rollback semantics.

15. The system of claim 2, wherein the Settlement Bus performs layer-2 batching and deterministic rollback across CBDC, stablecoin, and bank RTGS bridges.

16. The method of claim 1, wherein NFT-based data licenses govern access to de-identified medical, financial, or IoT datasets and enforce metering limits on queries or computation cycles.

17. The system of claim 2, wherein IoT devices each possess a decentralized identifier (DID) and produce dual-signed measurements verifiable under the BEISIGN protocol.

18. The system of claim 2, wherein navigation signals are dual-signed with satellite institutional identifiers (EID) and receiver decentralized identifiers (DID) to mitigate spoofing.

19. The system of claim 2, wherein behavior data generate BEI-Token units, identity credentials generate BEI-NFT units, lifestyle events generate LifeCoin units, and time commitments generate TimeCoin units.

20. The system of claim 2, wherein exchangeable assets include patents, digital identities, and domain name namespaces including BEIDID, BEIEID, and DRIDX operated across TLDs, and are listed and traded on at least one of BEIGX, BEISX, or BEICX under BEISIGN verification.
